(19) United States
(12) Patent Application Publication
(10) Pub. No.: US 2023/0023263 A1
(43) Pub. Date: Jan. 26, 2023

(54) MULTILENS DIRECT VIEW NEAR EYE DISPLAY

(71) Applicant: Reality Plus Ltd., Kfar Saba (IL)

(72) Inventors: Shay CHAIM, Even Yehuda (IL); Aviad HELLMAN, Matan (IL); Pinchas SHPATER, Haifa (IL); Daniel GRINBERG, Hod Hasharon (IL); Guy RAZ, Binyamina (IL)

(21) Appl. No.: 17/785,068

(22) PCT Filed: Dec. 17, 2020
(86) PCT No.: PCT/IL2020/051305

§ 371 Date: Jun. 14, 2022

Related U.S. Application Data
(60) Provisional application No. 62/948,845, filed on Dec. 17, 2019.
(60) Provisional application No. 62/957,320, filed on Jan. 6, 2020.
(60) Provisional application No. 62/957,321, filed on Jan. 6, 2020.
(60) Provisional application No. 62/957,323, filed on Jan. 6, 2020.
(60) Provisional application No. 62/957,325, filed on Jan. 6, 2020.
(60) Provisional application No. 63/085,224, filed on Sep. 30, 2020.

(51) Int. Cl. G02B 27/01

(52) U.S. Cl. CPC G02B 27/0172; G02B 2027/0116

(57) ABSTRACT

A system includes a plurality of stacked optical channels and a channel image adapter. Each optical channel includes at least a portion of a lens and at least a portion of a display and handles a portion of a phase space of the optical device. The channel image adapter adapts an input image into image portions for projection from the displays, one per optical channel. The input image includes data pixels each having a pixel display angle. The channel image adapter places copies of each data pixel into the image portions for those of the optical channels whose phase space includes the pixel display angle of the data pixel.

### CROSS REFERENCE TO RELATED APPLICATIONS

This application claims priority from U.S. patent application 62/948,845, filed Dec. 17, 2019, U.S. patent application 62/957,320, filed Jan. 6, 2020, U.S. patent application 62/957,321, filed Jan. 6, 2020, U.S. patent application 62/957,323, filed Jan. 6, 2020, U.S. patent application 62/957,325, filed Jan. 6, 2020, and U.S. patent application 63/085,224, filed Sep. 30, 2020, all of which are incorporated herein by reference.

### FIELD OF THE INVENTION

The present invention relates to near eye displays generally and to virtual reality headsets in particular.

### BACKGROUND OF THE INVENTION

Images displayed on large computer and TV screens are known. When viewing such images, the distance between the display and the viewer's eye is typically between 30 cm and 3 m. Viewing images on personal, near eye displays (NEDs) brings the display closer to the viewer's eyes. This allows users to privately view images, and also allows for an immersive experience, as the eyes only see the images displayed on the near-eye display. Such NED displays can be linked to inertial positioning systems to allow the image to ‘move’ with the movement of the user. This may make the user feel as if they are ‘in’ the image. This immersive experience has application for movies, gaming, and real time remote interaction with remote machines with cameras—e.g., hazardous environmental operations, telemedicine, and undersea exploration.

Virtual Reality (VR) headsets and compatible CGIs are known in the art. FIG. 1, to which reference is now made, shows top view of a typical VR headset 1 which is held on the head by side straps 2 and overhead straps 3. VR headset 1 comprises two near eye displays 4, to project images for the left and right eyes 8, and an optical system 5 that projects such images into the viewer's eyes 8. Typically, near eye display assembly 4 is approximately 50 mm wide per eye and placed at an eye relief distance (i.e., no further than necessary to provide the eyelashes with room to move) of approximately 10-30 mm from eye 8. These VR headsets aim to give the user wide fields of view and quality image, which require complicated lens and display systems, resulting in a large eye-display distance (EDD) 9 of about 8 cm from display 4 to eye 8. As a result, VR headset 1 is uncomfortable to use due to its bulk at such a large eye-display distance 9.

### SUMMARY OF THE PRESENT INVENTION

There is therefore provided, in accordance with a preferred embodiment of the present invention, a system including a plurality of stacked optical channels and a channel image adapter. Each optical channel includes at least a portion of a lens and at least a portion of a display and handles a portion of a phase space of the system. The channel image adapter adapts an input image into image portions for projection from the displays, one per optical channel. The input image includes data pixels each having a pixel display angle. The channel image adapter places copies of each data pixel into the image portions for those of the optical channels whose phase space includes the pixel display angle of the data pixel.

There is also provided, in accordance with a preferred embodiment of the present invention, a near eye display system including, per eye, a compound lens formed of multiple lens portions of short effective focal length (EFL) lenses, a display unit including multiple displays, one per lens portion, and an image adapter to adapt an input image into image portions, one per-display. The compound lens, display unit and image adapter operate to provide a field of view of over 60 degrees and an eyebox at least covering the range of pupil motion of the eye.

Moreover, in accordance with a preferred embodiment of the present invention, the system includes a housing useful for virtual reality or augmented reality.

Further, in accordance with a preferred embodiment of the present invention, the system of claim 1 also includes a plurality of channel correctors, one per optical channel, each to provide compensation to its associated image portion in order to correct imaging errors of its associated lens and to display its corrected image portion on its associated display.

Still further, in accordance with a preferred embodiment of the present invention, the system has optical axes which are tilted with respect to each other.

Moreover, in accordance with a preferred embodiment of the present invention, the system has at least one the display which is off-center with respect to an optical axis of its the lens or lens portion.

Further, in accordance with a preferred embodiment of the present invention, at least one lens or lens portion is cut from a donor lens.

Still further, in accordance with a preferred embodiment of the present invention, the cut is asymmetric about an optical axis of its the donor lens.

Moreover, in accordance with a preferred embodiment of the present invention, the system also includes optical separators between neighboring channels, neighboring lenses or lens portions.

Further, in accordance with a preferred embodiment of the present invention, the imaging errors include at least one of color aberration and image distortion.

Still further, in accordance with a preferred embodiment of the present invention, the lenses from the optical channels are formed into a compound lens.

Moreover, in accordance with a preferred embodiment of the present invention, the displays from the optical channels are formed into a single display.

Further, in accordance with a preferred embodiment of the present invention, the displays from the optical channels are separated from each other by empty display areas.

Still further, in accordance with a preferred embodiment of the present invention, each optical channel has an eye-display distance of no more than 30 mm.

There is also provided, in accordance with a preferred embodiment of the present invention, a near eye display system including an optical system, a processor and a housing on which the optical system and processor are mounted close to a pair of human eyes. The optical system includes, per eye, a plurality of stacked optical channels, each optical channel including at least a lens and at least a portion of a display. Each optical channel handles a portion of a phase space of the optical system. The processor includes a channel image adapter and a plurality of channel correctors, one per optical channel. The channel image adapter adapts an input image into image portions, one per optical channel. The input image includes data pixels each having a pixel display angle. The channel image adapter places copies of each data pixel into the image portions for those of the optical channels whose phase space includes the pixel display angle of the data pixel. Each channel corrector provides compensation to its associated image portion to correct imaging errors of its associated lens and to display its corrected image portion on its associated display.

There is also provided, in accordance with a preferred embodiment of the present invention, a compound lens including a plurality of lens portions, each portion cut from a donor lens having a short EFL. The lens portions are glued together in a stacked arrangement.

There is also provided, in accordance with a preferred embodiment of the present invention, a method including stacking optical channels, each optical channel including at least an optical element such as a lens and at least a portion of a display, each optical channel handling a portion of a phase space of the optical device, and adapting an input image into image portions for projection from the displays, one per optical channel, the input image including data pixels each having a pixel display angle. The adapting includes placing copies of each data pixel into the image portions for those of the optical channels whose phase space includes the pixel display angle of the data pixel.

Moreover, in accordance with a preferred embodiment of the present invention, the method also includes providing per-optical-channel compensation to each associated image portion in order to correct imaging errors of its associated lens, thereby to produce a per-channel corrected image portion, and displaying each per-channel corrected image portion on its associated the display.

Further, in accordance with a preferred embodiment of the present invention, the method also includes tilting optical axes of the optical channels with respect to each other.

Still further, in accordance with a preferred embodiment of the present invention, the method also includes positioning at least one the display off-center with respect to an optical axis of its the lens.

Moreover, in accordance with a preferred embodiment of the present invention, the method also includes cutting at least one the lens from a donor lens.

Further, in accordance with a preferred embodiment of the present invention, the cutting is asymmetric about an optical axis of its the donor lens.

Still further, in accordance with a preferred embodiment of the present invention, the method also includes placing optical separators between neighboring the optical channels.

Finally, in accordance with a preferred embodiment of the present invention, the imaging errors include at least one of color aberration and image distortion.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is schematic top view of a typical VR headset;

FIG. 2 is a diagrammatic illustration a phase space diagram;

FIG. 3 is a phase space diagram and a ray tracing diagram of a prior art VR headset;

FIG. 4 is a phase space diagram and a ray tracing diagram of a prior art VR headset and a reduced size system;

FIGS. 5A and 5B are top view and schematic views respectively of a novel pair of VR glasses;

FIG. 6 is a phase space diagram and a ray tracing diagram for the prior art VR headset and for one half of the glasses of FIG. 5A having two optical channels;

FIG. 7 is a ray tracing diagram for one half of the glasses of FIG. 5A having three tilted optical channels;

FIG. 8 is a phase space diagram and a ray tracing diagram for the optical channels of FIG. 7 compared to those of single large prior art lens;

FIG. 9 is a phase space diagram and a ray tracing diagram for an exemplary VR unit having two optical channels with lens sections;

FIG. 10 is a schematic illustration of an exemplary compound lens aligned with an array of displays;

FIG. 11 is a schematic illustration of the operation of a channel image adapter, useful in the glasses of FIG. 5B;

FIG. 12 is a schematic illustration of the operation of each channel corrector, useful in the glasses of FIG. 5B;

FIG. 13 is a schematic illustration of an alternate embodiment of the glasses of FIG. 5A for augmented reality (AR);

FIGS. 14A and 14B are top view illustrations of one embodiment of a single combined display and its juxtaposition with lens sections of a compound lens;

FIG. 15A is a top view illustration of how to align lens sections with display segments 35; and

FIGS. 15B and 15C are front view illustrations showing where lens sections may be cut from donor lenses for two types of lens sections.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that users prefer may smaller and less bulky virtual reality (VR) headsets. such as headsets close to or at the position where eyeglasses are held, reducing the eye-display distance (EDD) accordingly. Unfortunately, significantly reducing EDD decreases the size of the optical components of the relevant VR headset which, in turn, reduces the optical quality of the image.

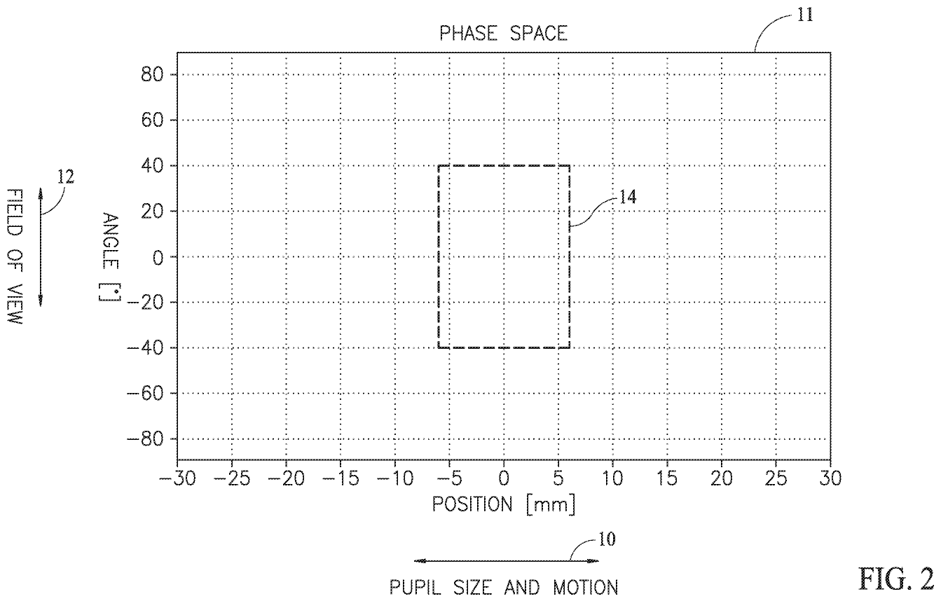

To understand this, consider FIG. 2, to which reference is now made. FIG. 2 illustrates a phase space diagram 11 graphing position of the pupil of one eye against angles of incidence of light on the pupil. Arrow 10 indicates the range of pupil positions around a position looking straight-ahead (noted as the 0 position) to which a user may move his/her eyes. This may provide flexibility in initially placing the VR headset and may enable the natural pupil movement when the eye scans different parts of the projected scene. The range is generally from about −7 mm to +7 mm. Arrow 12 indicates the range of angles of incidence of light that an optical system generally should cover and may, for example, range from −40 degrees to +40 degrees from the straight-ahead position. Thus, for an optical system to provide full optical coverage, it needs to be able to span a rectangle 14 of the space-angle phase space.

It will be appreciated that FIG. 2, and the other phase space diagrams of the present description, as well as the ray tracing diagrams, are schematic and show idealized performance. As a result, they ignore real-life effects, such as vignetting and aberrations. Moreover, they schematically show only the front-most eye-piece lens and do not show any additional optical components, such as may be warranted. Moreover, it is to be understood that the present discussion is for a single eye but is applicable for both eyes.

It is also to be understood that diagram 11, as well as all phase-space diagrams described hereafter, and as well as all ray tracing diagrams hereafter, depict pupil position and field of view angles along a single one-dimensional axis. It should be understood that the same considerations are applicable for both two-dimensional lateral axes of pupil position and scene angles.

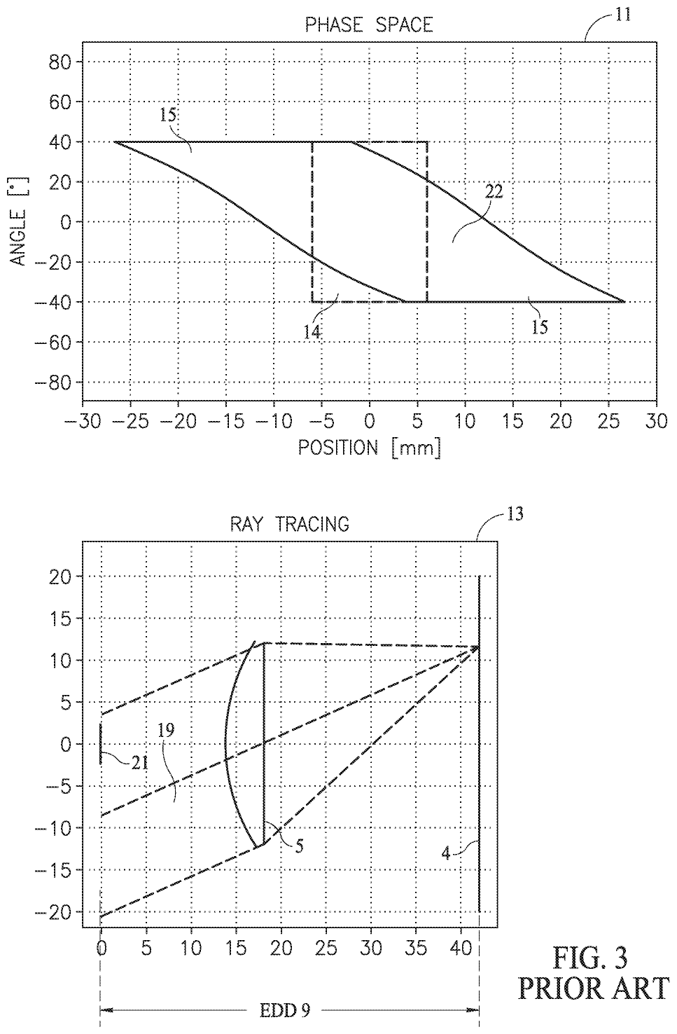

Prior art VR systems, like VR headset 1, respond to such a large phase space requirement with large optical systems, as shown in FIG. 3, to which reference is now briefly made. FIG. 3 shows phase space diagram 11 for an optical system, represented by prior art lens 5, and a ray tracing diagram 13 for lens 5. Ray tracing diagram 13 shows some rays exiting a specific point in display 4, through lens 5, and reaching a plane of the pupil, where the X axis and Y axis show space coordinates. Phase space diagram 11 indicates that the phase space illuminated at the pupil plane by the lens 5 and display 4 forms a parallelogram 22 rather than rectangle 14. It is noted that parallelogram 22 does not cover all of rectangle 14. In particular, while the field of view (FOV) for VR system 1 is as desired (from −40 degrees to +40 degrees), the range of pupil motion is too much at some angles of incidence and too little at other angles. Specifically, phase space diagram 11 indicates that lens 5 shines light into large portions of the phase space which are outside of rectangle 14, such as the sharp tips 15 of parallelogram 22. As Applicant has realized, illuminating these portions of phase space is not useful and therefore represents power waste by the system.

Ray tracing diagram 13 shows light rays from a pixel in the upper portion of prior art display 4 as they diverge towards lens 5. Note that, since the human brain identifies objects at a distance by the fact that the light coming from the object is collimated (i.e., parallel rays), lens 5 collimates the light from display 4 into a beam 19. In FIG. 3, beam 19 is significantly wider than a pupil 21.

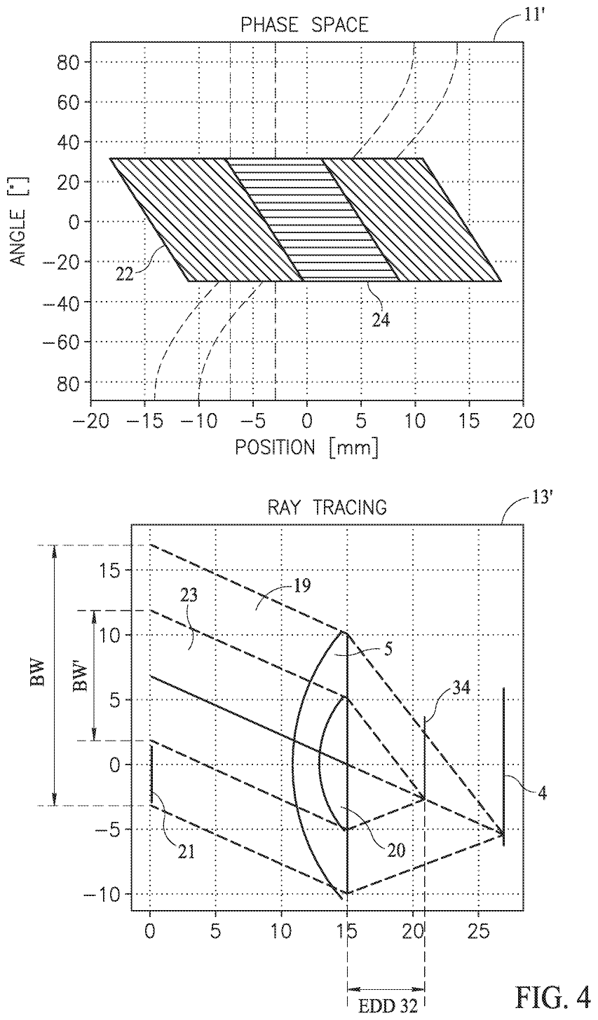

Compare this to FIG. 4, to which reference is now made, which illustrates what happens when the optical system is reduced in size, with phase space diagram 11′ and ray tracing diagram 13′. FIG. 4 shows the phase space and ray tracings both for the system of lens 5 and display 4 and for the reduced size system of a smaller lens 20 and a smaller display 34. In this example, lens 20 is half the diameter of prior art lens 5 and, accordingly, display 34 is closer to lens 20 by half the distance of lens 5 to display 4. The ray tracings depicted for both lenses are for a single pixel at the lower edge of the relevant displays.

Note that the phase space 24 of the smaller system has, per eye, the same FOV (from −40 degrees to +40 degrees) as phase space 22 of larger system. However, its “eyebox”, the range of positions of pupil 21 that is covered, is half the size. This can also be seen in ray tracing diagram 13′ where a beam width BW of beam 19 of prior art lens 5 is 20 mm while a beam width BW′ of lens 20 is only 10 mm wide. Thus, the smaller lens 20 has a narrower beam 23. The result of this is that, for some positions of pupil 21, pupil 21 will be within beam 19 but not within the narrower beam 23 and therefore, will not see the displayed data. The resultant smaller eyebox means either that the users cannot move their eyes or they will only see part of the displayed data.

However, Applicant has realized that, by dividing the optical components into multiple, stacked optical channels, quality images, with a full sized eyebox and an acceptably wide field of view (FOV), may be achieved for a near eye display (NED).

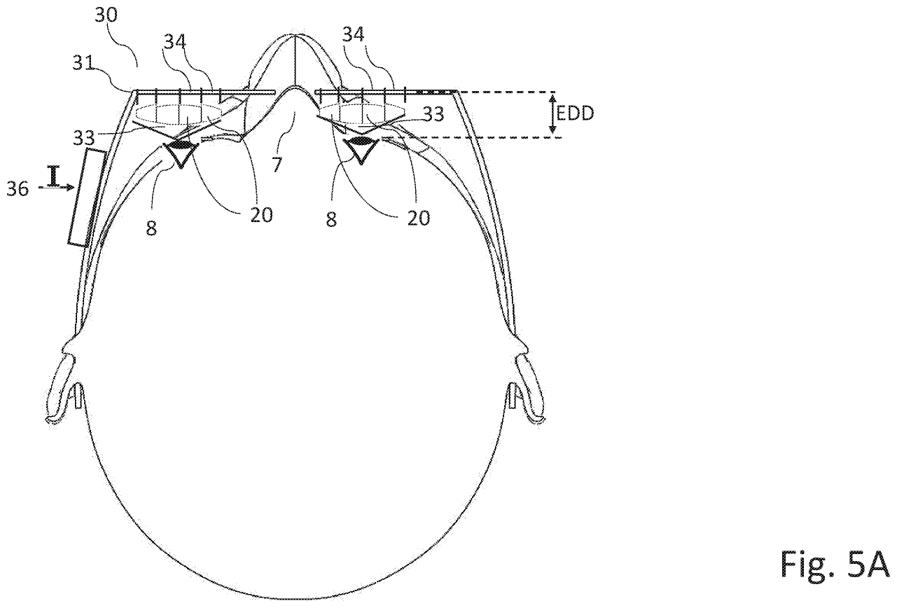

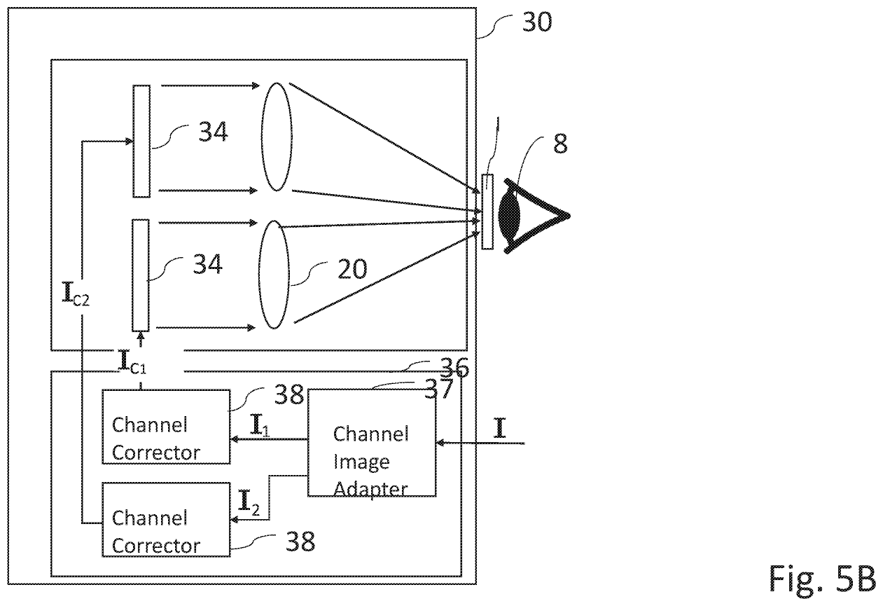

Reference is now made to FIGS. 5A and 5B, which respectively illustrate a novel pair of VR glasses 30 in a top view and in a schematic view. FIG. 5A shows an eyeglass type frame 31, with a minimum eye-display distance EDD 32. For example, EDD 32 might be in the range of the distance from human eye 8 to a typical human nose 7. For example, eye-display distance EDD 32 may be at least 30 mm. Minimal EDD 32 may provide glasses 30 with a reduced system footprint.

Mounted on frame 31 may be at least multiple reduced size displays 34 and at least multiple reduced sized lenses 20 per eye, as well as a processing unit 36. In accordance with a preferred embodiment of the present invention, each display 34 and lens 20 may be sized to match eye-display distance EDD 32 and may comprise a separate optical channel 33 to which processor 36 may separately provide images. It will be appreciated that each optical channel 33 may also include other optical elements as necessary.

FIG. 5B illustrates the multiple channel processing and shows the elements of processing unit 36 as well as displays 34, lenses 20 and one eye 8. Processing unit 36 may comprise a channel image adapter 37 and multiple channel correctors 38. Channel image adapter 37 may receive an image I, such as a computerized graphics image (CGI), for display and may select a segment Iᵢ of image I relevant for each optical channel 33, as described in more detail hereinbelow. Each channel corrector 38 may process its received image segment Iᵢ, as described in more detail hereinbelow, to correct for the individual optical distortions and aberrations of its relevant optical channel 33, producing its corrected image segment I_{ci} for its associated display 34. Each display 34 may display its corrected image segment I_{ci} and the display's associated lens 20 may introduce distortion and aberration effects to the displayed corrected image, such that the generated image segment Iᵢ would be collimated toward eye 8 with reduced distortion and aberration. Eye 8 may view all of segments Iᵢ and, since the light received is collimated, eye 8 may see a near perfect image I, and may perceive it as though it was at a distance.

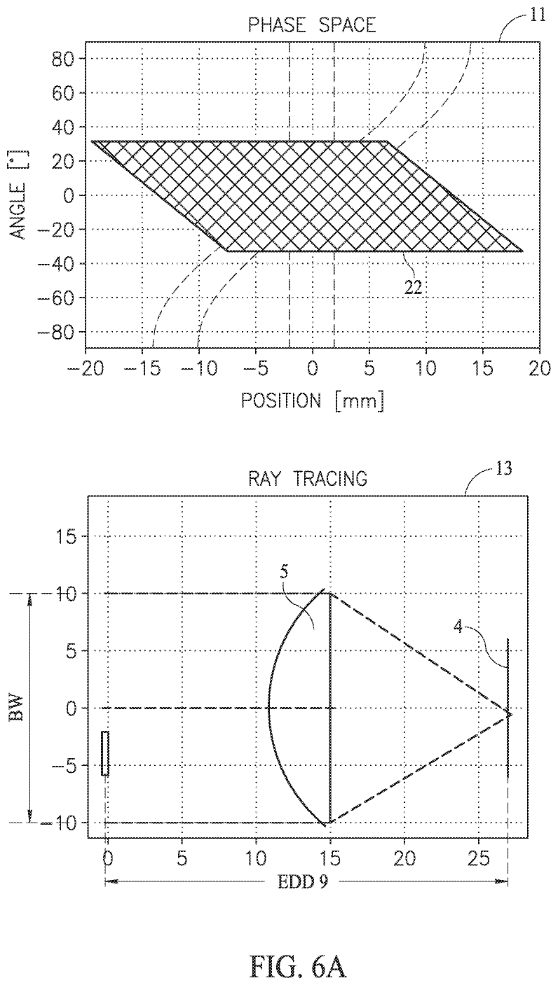

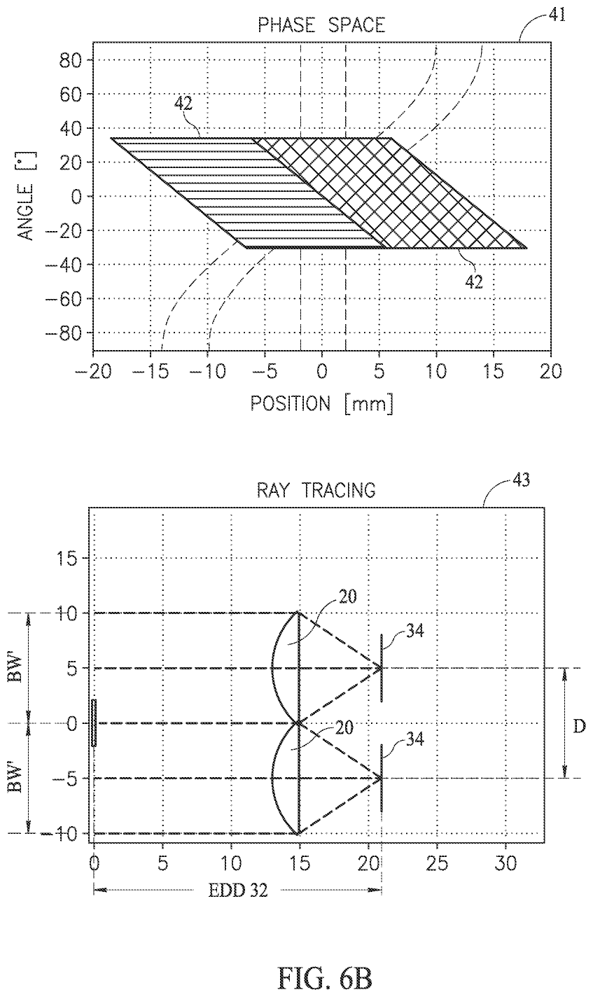

As mentioned hereinabove, multiple, stacked optical channels may provide a full sized eyebox. This is illustrated in FIG. 6, to which reference is now made. FIG. 6 shows phase space diagram 11 and ray tracing diagram 13 of FIG. 3 for prior art VR lens 5 along with a phase space diagram 41 and a ray tracing diagram 43 for one half of VR glasses 40 having two optical channels 33. Each channel 33 may have reduced EDD 32, where the distance between displays 34 and lenses 20 (defined as the effective focal length (EFL) of lenses 20) is half the distance between prior art display 4 and lens 5.

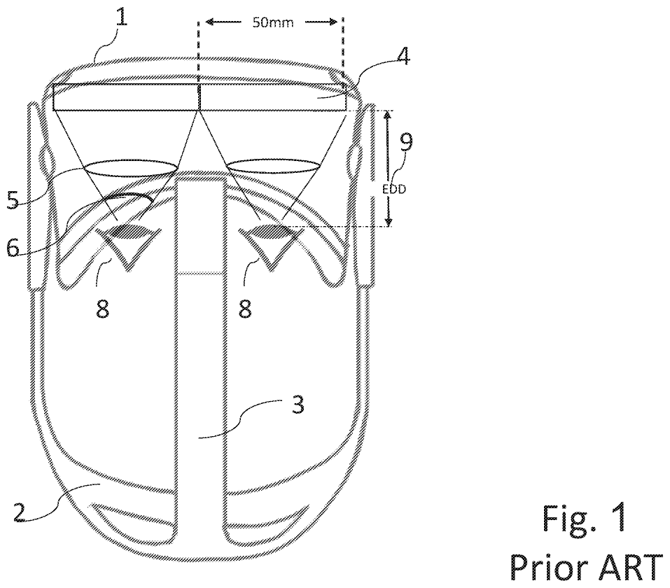

Note that, while each per-channel phase space 42 is smaller than prior art phase space 22, their combined phase space is the same size and covers the same area as prior art phase space 22. Moreover, while each beam width BW′ may be smaller than prior art beam width BW, the combined beam width is the same and covers the same range of angles of incidence. Thus, the eyebox of VR glasses 30 is the same as that for prior art headset 1 (FIG. 1).

FIG. 6 shows two stacked optical channels 33. As can be seen, channels 33 are stacked ‘next’ to each other and there may be a distance D between central optical axes of their respective lenses 20.

It will be appreciated that graphs 43 in FIG. 6 illustrate rays only for the central pixel in both displays 34. It will be appreciated that each piece of data in the image has its own pixel angle (i.e., angle to the horizontal) to which its light is collimated. The pixel angle PA is defined as:

PA=Tan⁻¹(PP/EFL) Equation 1

where pixel angle PA is the angle of the collimated beam 23 providing light from pixel P.

It is noted that the human eye/brain system sees collimated beams having the same angle as coming from a single object. Applicant has realized that, as long as the piece of data is displayed such that its pixel angle is the same from all of the displays 34 through which it is displayed, then the human eye/brain system translates all of the beams from the different displays 34 as coming from the same location in space. It is this fact which enables the eyebox recovery discussed hereinabove, even if the data is projected from different displays 34.

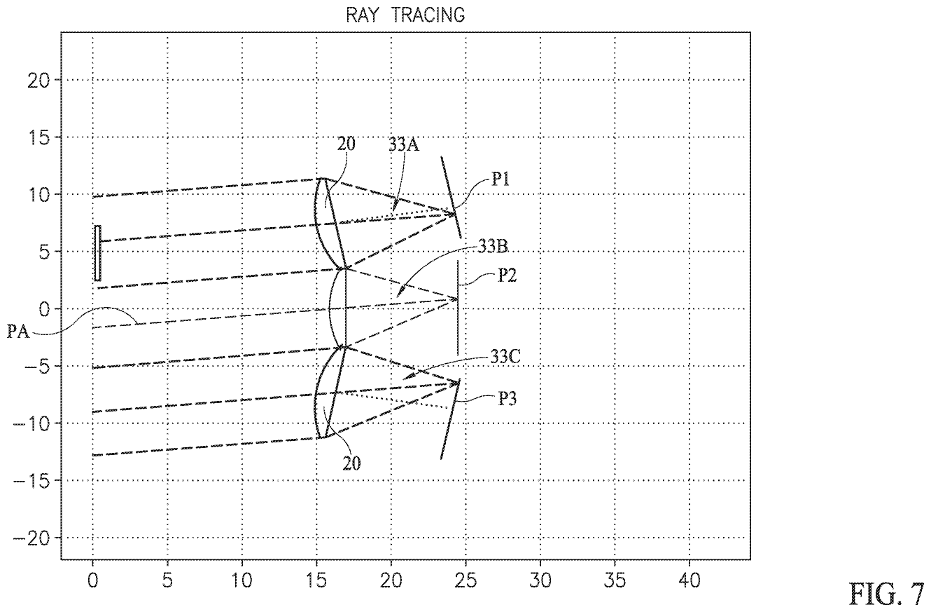

This is illustrated in FIG. 7, to which reference is now made. In this embodiment, three optical channels 33 are shown. In channel 33A, a lower pixel P1 is highlighted, in channel 33B, a middle pixel P2 is highlighted and in channel 33C, a higher pixel P3 is highlighted. However, the ray tracing of FIG. 7 shows that each of these pixels, P1, P2 and P3, is collimated to the same angle PA. This provides a total wide eyebox. FIG. 7 shows pupil 21 moving from the beam of channel 33B to the beam of channel 33A and still seeing the same data. Thus, channel image adapter 37 may be designed to display the same data at each of pixels P1, P2 and P3. Standard optical calculations may be utilized to determine which pixel is seen at which angle. Moreover, a standard optical calibration process may be performed at manufacture on each lens 20 to compensate for any assembly tolerances and to ensure that images are displayed correctly.

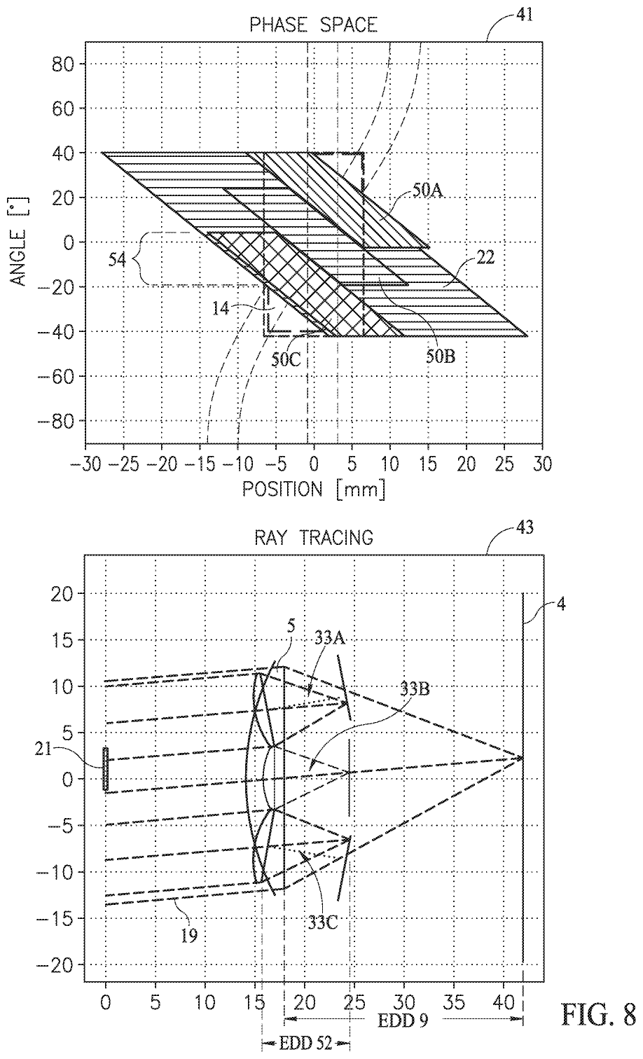

Note that FIG. 7 shows optical channels 33A, 33B and 33C which are tilted with respect to each other. Applicant has realized that the amount of tilt may be selected to provide a wider field of view FOV than may be possible without the tilt. This is shown in FIG. 8, to which reference is now made. FIG. 8 shows phase space diagram 41 and ray tracing diagram 43 for optical channels 33 of FIG. 7 compared to those of single large prior art lens 5.

As can be seen in phase space diagram 41, phase spaces 50A, 50B and 50C, for channels 33A, 33B and 33C, respectively, each fill only part of phase space 22 of prior art lens 5. However, as opposed to phase spaces 42 of FIG. 6 (for non-tilted lenses 20), which cover different ranges of eye positions but the same ranges of angles of incidence, phase spaces 50 are also vertically shifted from one another. Phase spaces 50 cover different ranges of eye positions and, more importantly, they cover different ranges of angles of incidence. For example, phase space 50C may cover angles −40 to +5 degrees while phase space 50B may cover angles −30 to +30 degrees.

As a result, tilted channels 33A-33C may, overall, cover a wider field of view than the non-tilted channels of FIG. 6. For example, the tilted channels may be used to provide a field of view as wide as that of prior art phase space 22, but, as mentioned hereinabove, in significantly smaller physical dimensions with the much shorter eye-display distance EDD.

It will be appreciated that, due to the tilt, VR glasses 30 may have a slightly smaller EDD 52 than the non-tilted EDD 32, which may be advantageous. It will also be appreciated that the overall phase space of tilted channels 33A-33C may cover the same amount of rectangle 14 as prior art phase space 22 but may extend significantly less outside of rectangle 14 and thus, may waste significantly less power projecting data to locations not seen by the user.

Furthermore, phase spaces 50A-50C may be utilized to determine where on each display 34 to display each piece of data, since each channel 33 may handle only certain angles of incidence. Note that phase spaces 50A-50C have areas of overlap and areas that don't overlap. For example, channels 33C and 33B both handle overlap area 54, the range of angles from −30 to +5 degrees, while channel 33C is the only channel which handles the range of angles from −40 to −30 degrees. Channel image adapter 37 may provide image data to displays 34 of the overlapped channels 33 for those angles of incidence in overlap areas, such as overlap area 54.

The number of lenses 20 and displays 34 may be selected to provide the desired optical phase space for the desired physical dimensions of VR glasses 30. Applicant has realized that, to further reduce physical dimensions, lenses 20 may be cut into lens sections. This may provide optical performance improvements by using portions of lenses 20 where optical performance may be generally better

As is known, with any optical system, image quality drops towards the edges of the beams. As a result, prior art optical systems utilize wide lenses, to avoid the beam edges. However, Applicant has realized that stacked channels 33A-33C, utilized for compensating for beam width reduction, may provide a further advantage, by compensating for any distortions caused by removing lens edges. Moreover, cutting the lens need not be symmetric around the center. Instead, as described below, there may be a displacement between the center of the lens and the center of the cut. This may allow the displays to be adjusted to the lens angle so that the displays may be placed in a more efficient way.

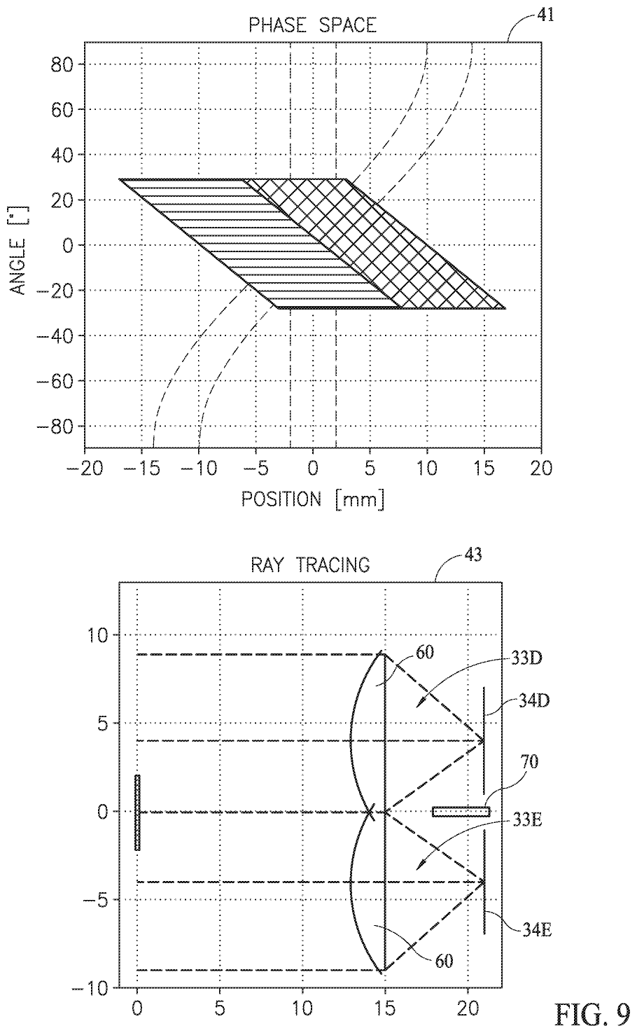

Reference is now made to FIG. 9, which illustrates phase space diagram 41 and ray tracing diagram 43 for an exemplary VR unit having two optical channels 33D and 33E with lens sections 60 rather than lenses 20. As can be seen, each lens section 60 may be cut on the side neighboring the other lens section 60. While the field of view has stayed the same (from −30 to +30 degrees in phase diagram 41), the eyebox is somewhat reduced (from about −8 to about +8 mm in ray tracing 43) compared to the uncut version of FIG. 6 (where it is from −10 to +10 mm), due to the smaller lens sections 60. However, as explained above, due to the removal of the edges of the lenses in the region where the beams are joined, image quality in this beam region is improved.

FIG. 9 also shows an optional separator 70 between channels 33D and 33E, which may act to prevent stray light, light bleed or light leakage between channels. Optional separator 70 may have any suitable form. It may be a mechanical separator between displays 34, a physical separation between displays 34 or a mechanical light isolation matrix between lenses 20 or lens sections 60 and eye 8. In addition, as discussed in more detail hereinbelow, if displays 34 are implemented on a single display, separator 70 may be implemented by blank areas between the display areas implementing each display 34. In the latter embodiment, mechanical separators may also be utilized to further improve the optical quality of VR glasses 30.

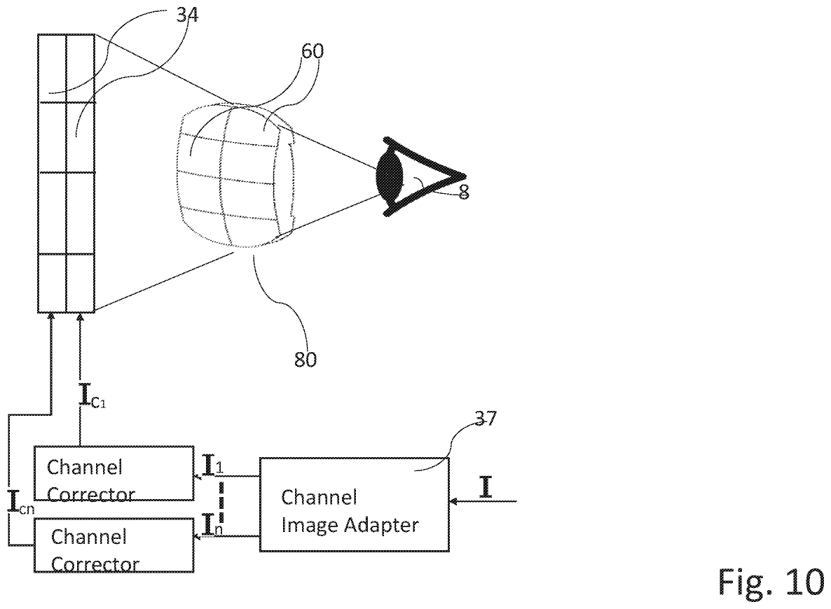

It will be appreciated that any suitable number of lenses 20 and/or lens sections 60 may be combined together, such as, for example, with a suitable glue, into a single compound lens 80. Lenses 20 and/or lens sections 60 may be arranged in either a 1-dimensional or 2-dimensional array. FIG. 10, to which reference is briefly made, illustrates an exemplary compound lens 80 comprised of a 2×4 array of lens sections 60 aligned with a 2×4 array of displays 34. Thus, each display 34 may be aligned with its associated lens section 60, thereby generating its optical channel 33 (not shown). Moreover, as mentioned hereinabove, channel image adapter 37 may adapt the input image I to each channel 33 and each channel corrector 38 may distort its channel image to correct for the distortions of its optical channel.

In an alternative embodiment, lens sections 60 may be tilted with respect to each other, as discussed with respect to FIG. 8.

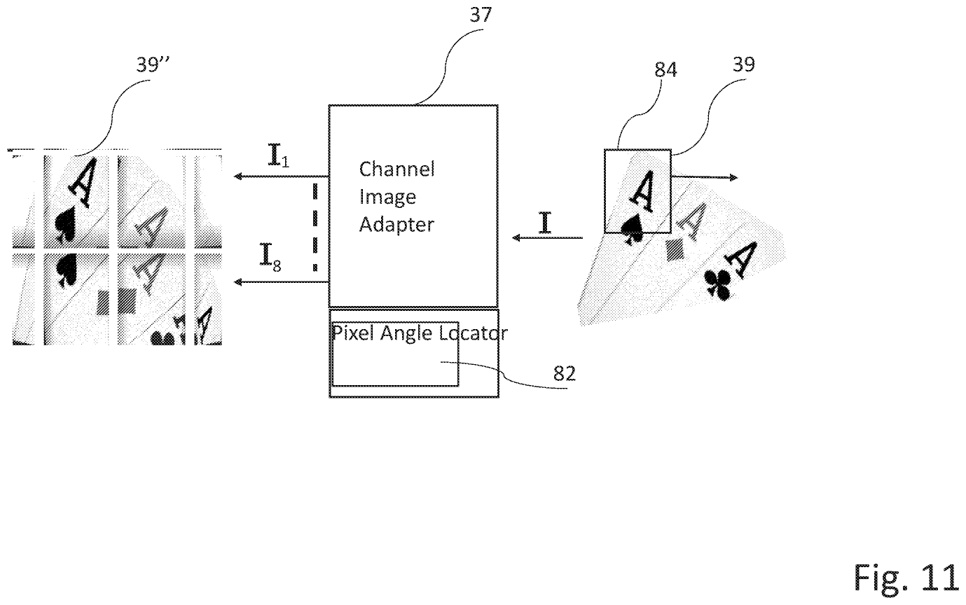

Reference is now made to FIG. 11 which illustrates the effect of channel image adapter 37 when dividing image I into an exemplary set of two by four image segments Iᵢ. FIG. 11 also shows an exemplary input image 39 of 3 playing cards and a set of output images 39″ for channels 33.

Channel image adapter 37 may place copies of each data pixel into image segments Iᵢ for those optical channels whose phase space includes pixel angle PA of the data pixel. Channel image adapter 37 may comprise a pixel angle locater 82 which may determine upon which display(s) 34 to display each pixel. To do so, pixel angle locater 82 may slide a window 84 across image I, moving window 84 by an amount related to the amount of overlap between phase spaces 50. Channel image adapter 37 may then associate the portion of the image within window 84 as image segment Iᵢ. Window 84 may be of the size of each display 34 or a portion of it.

Note that, due to the work of pixel angle locator 82, parts of the image of the playing cards are repeated.

Once channel image adapter 37 has placed each pixel of input image I in the correct locations and segmented the image according to channels 33, each channel corrector 38 may compensate for the optical distortion its channel 33 introduces to its image segment Iᵢ.

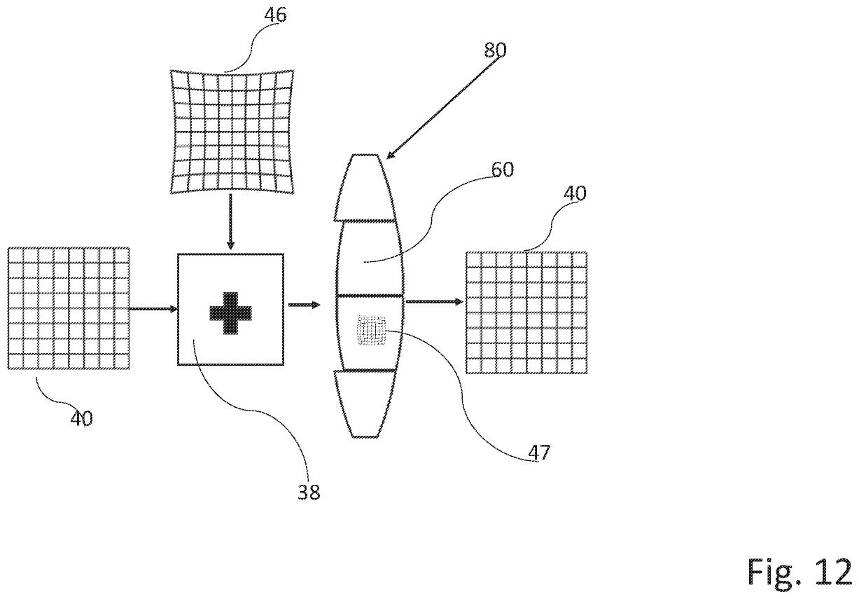

Reference is now made to FIG. 12 which illustrates the operation of each channel corrector 38. Channel corrector 38 adds compensation 46 to correct imaging errors, such as distortion and/or aberration, to image segment Iᵢ to produce compensated image segment Iᵢ. When compensated image segment I_{ci} is projected through lens section 80 of compound lens 60, imaging errors 47 is added to compensated image segment I_{ci} which cancels the effect of compensation 46. The resulting image segment Iᵢ viewed by the user may have little or no imaging errors.

The primary type of imaging error 47 may be distortion which, for lens segments 60, may be barrel distortion. To compensate for barrel distortion, channel corrector 38 may add a compensation 46 known as “pin cushion” distortion; however, it will be appreciated that other types of distortions may be introduced by each channel 33.

Each channel corrector 38 may utilize the results of any suitable lens characterization operation, which may be performed a priori, such as after manufacture of each lens section 60 or lens 20. The per-segment distortion may be defined by predefined parameters such as form, color and other factors of a lens 20 or lens section 60.

Correction factors for each lens 20 or lens section 60 may then be stored in its associated channel corrector 38 and the appropriate compensating distortion calculation may then be implemented in the relevant channel corrector 38. One suitable compensation calculation may be that described in the article by K. T. Gribbon, C. T. Johnston, and D. G. Bailey entitled “A Real-time FPGA Implementation of a Barrel Distortion Correction Algorithm with Bilinear Interpolation”, published online at http://sprg.massey.ac.nz/pdfs/2003_IVCNZ_408.pdf and discussed in the Wikipedia article on Distortion (optics).

Another suitable correction may be that of color aberration which consists of local shifting in the image the red (R), green (G) and blue (B) image layers relative to one another. The amount of relative shifting is calibrated such that it will cancel the different displacements each R, G and B color layer undergoes when projected through the optical system.

In an alternate embodiment of the present invention, there may be a single channel corrector 38 which may store correction factors for each channel and may implement the same functionality for each channel but with its correction factors.

It will be appreciated that the present invention may provide a comfortable set of VR glasses 30 whose physical dimensions are those of a pair of eyeglasses. With its multiple, stacked optical channels 33 and processor 36, it provides a full field of view and a full range eyebox.

In addition, Applicant has realized that the “stacked channels” approach of the present invention may reduce the amount of power that VR glasses 30 may utilize. This may be because, in VR glasses 30, each display 34 may cover a smaller portion of the pupil of each eye 8. As a result, the total amount of projected brightness in VR glasses 30 may be less for the same user experience.

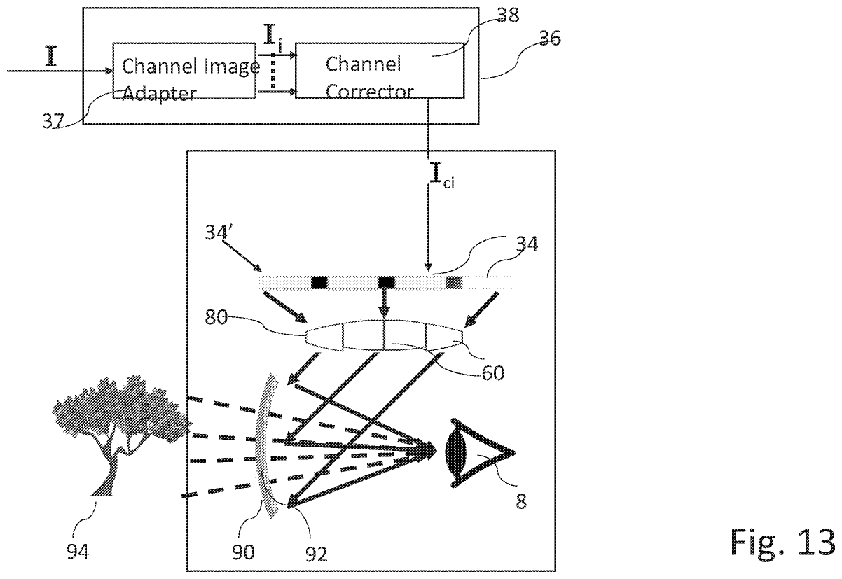

Moreover, the combined multiple, stacked optical channels 33 and processor 36 may be adjusted and configured for a large set of optical systems. For example, it may be adapted for use in an augmented reality (AR) glasses system such as that shown in FIG. 13, to which reference is now briefly made. FIG. 13 shows, for a single eye 8, processor 36, a single combined display 34′ formed of multiple displays 34 and compound lens 80 formed of multiple lens sections 60. In this embodiment, the output of each channel 33 may be projected onto the inside of a combiner 92, such as a semi reflective lens, of a pair of glasses 90, to ‘add’ a virtual image into a ‘real’ image, indicated by the tree 94, viewed through combiner 92 by the user.

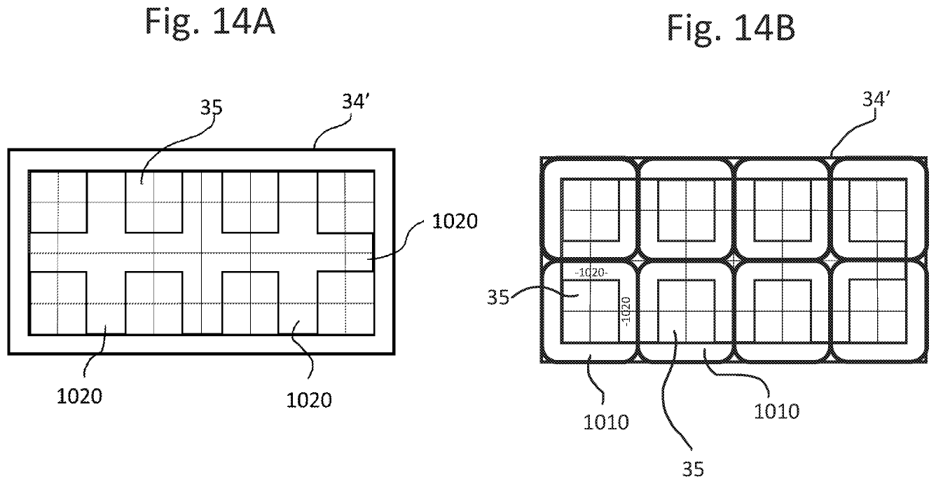

As mentioned hereinabove, VR glasses 30 may be implemented with single combined display 34′ and with compound lens 80. This is shown in FIGS. 14A and 14B, to which reference is now made, which illustrate a top view of one embodiment of single combined display 34′ and its juxtaposition with lens sections, here labeled 1010, of compound lens 80, respectively. In this embodiment, combined display 34′ may comprise 8 square display segments 35 in two rows of 4 display segments 35 each, separated from each other by empty segments 1020. Each display segment 35 may act as one display 34 of an optical channel 33 and, as discussed hereinabove, empty segments 1020 may be utilized to reduce light bleeding between neighboring display segments 35.

For example, display 34′ may be a 10.5 mm by 17.5 mm display and display segments 35 may each be 3 mm×3 mm. Empty segments 1020 may provide 1-3 mm between adjacent sides of neighboring display segments 35 and 0.5 mm around the outer edges. As shown in FIG. 14B, each lens section 1010 may cover its associated display segment 35 and an associated portion of its neighboring empty segments 1020.

As previously shown in FIG. 10, compound lens 80 may be formed of two rows of lens sections 1010. In this embodiment, each lens section 1010 may be cut from a separate donor lens 1025.

Lens sections 1010 are shown in FIG. 14B, juxtaposed upon display 34′ of FIG. 14A. As can be seen, each lens section 1010 is associated with each display segment 35 and its associated empty segments 1020. Together, the eight lens sections 1010 may cover almost the entirety of display 34.

As mentioned, display segments 35 may be associated with their lens section 1010. Thus, each display segment 35 may be displaced from the center of compound lens 80. Moreover, each display segment 35 may display its associated image portion (not shown). Thus, for each channel, its lens section 1010, display segment 35 and image portion are all aligned with each other.

It is noted that compound lens 80 may be used in combination with additional optical elements, which may be separated for each channel 33. It is also noted that compound lens 80 may be used with multiple displays 34 where the multiple displays 34 are arranged such that each lens section 1010 of the compound lens 80 projects towards the eye from a different display 34.

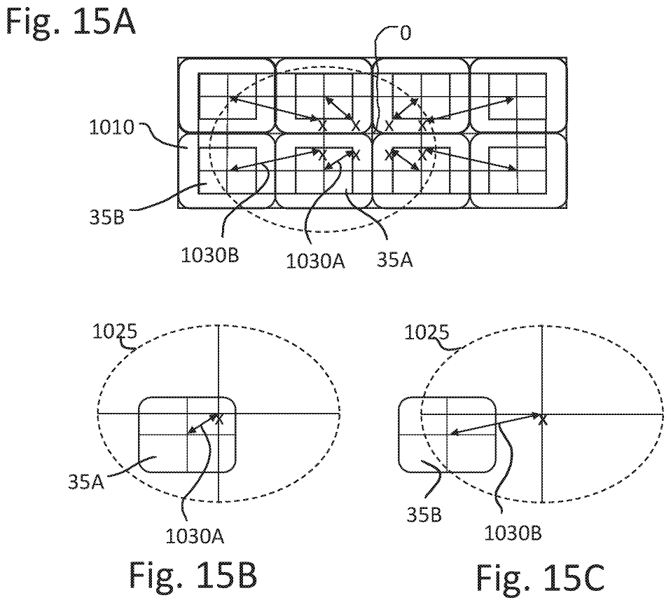

FIG. 15A, to which reference is now made, illustrates, in top view, how to align lens sections 1010 with display segments 35 to create each optical channel 33. The X's mark the centers of each donor lens 1025, defined so eye 8 may be able to see the associated image segment Ii. The location of centers X are defined by the size of each display segment 35, the effective focal length EFL of donor lenses 1025 and eye relief ER.

Each display segment 35 may be displaced from the center of its donor lens 1025 and the amount of displacement is indicated by an arrow 1030A or 1030B, associated with two types of display segments 35, the inner segments 35A and the outer segments 35B, respectively. The centers X for inner segments 35A are located equidistantly around a center O of combined display 34, at the relevant corner of each inner segment 35A, while the centers X for outer segments 35B are located at the center of each inner surface of each inner segment 35A, also equidistantly around center O.

For each lens section 1010, its associated arrow 1030 may extend from its associated donor lens center X to a center Os of its associated display segment 35. Accordingly, each display segment 35 may be off-center with respect to the optical center X of its lens section 1010. Moreover, each lens section 1010 may be asymmetrically cut from its donor lens 1025.

FIGS. 15B and 15C, to which reference is now briefly made, illustrate, in front view, where lens sections 1010 may be cut from donor lenses 1025 for each of the two types of arrows 1030A and 1030B, respectively. Each lens section 1010 may be the portion of the lens covering the relevant display segment 35 and its associated empty segments 1020 when the center of donor lens 1025 may be placed on its associated center X.

Note that, in FIG. 15C, donor lens 1025 may not fully cover its associated outer display segment 35B

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general-purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A system comprising:
a plurality of stacked optical channels, each optical channel comprising at least a portion of a lens and at least a portion of a display, each optical channel handling a portion of a phase space of said system; and
a channel image adapter to adapt an input image into image portions for projection from said displays, one per optical channel, said input image comprising data pixels each having a pixel display angle, said channel image adapter to place copies of each said data pixel into said image portions for those of said optical channels whose phase space includes said pixel display angle of said data pixel.

2. A near eye display system comprising:
an optical system, a processor and a housing on which said optical system and processor are mounted close to a pair of human eyes,
said optical system comprising, per eye:
a plurality of stacked optical channels, each optical channel comprising at least a portion of a lens and at least a portion of a display, each optical channel handling a portion of a phase space of said optical system; and
said processor comprising:
a channel image adapter to adapt an input image into image portions, one per optical channel, said input image comprising data pixels each having a pixel display angle, said channel image adapter to place copies of each said data pixel into said image portions for those of said optical channels whose phase space includes said pixel display angle of said data pixel; and
a plurality of channel correctors, one per optical channel, each to provide compensation of its associated said image portion to correct imaging errors of its associated lens and to display its corrected image portion on its associated display.

3. A near eye display system comprising, per eye:
a compound lens formed of multiple lens portions of short effective focal length (EFL) lenses;
a display unit comprising multiple displays, one per lens portion; and
an image adapter to adapt an input image into image portions, one per display,
said compound lens, display unit and said image adapter operating to provide a field of view of over 60 degrees and an eyebox at least covering the range of pupil motion of said eye.

4. The system of claim 1 and also comprising a housing useful for virtual reality or augmented reality.

5. The system of claim 1 and also comprising:
a plurality of channel correctors, one per optical channel, each to provide compensation to its associated said image portion to correct imaging errors of its associated lens and to display its corrected image portion on its associated display.

6. The system of claim 1 and having optical axes which are tilted with respect to each other.

7. The system of claim 1 and having at least one said display which is off-center with respect to an optical axis of its said lens or lens portion.

8. The system of claim 1 wherein at least one said lens or lens portion is cut from a donor lens.

9. The system of claim 8 wherein said cut is asymmetric about an optical axis of its said donor lens.

10. The system of claim 1 and also comprising optical separators between neighboring channels, neighboring lenses or neighboring lens portions.

11. The system of claim 5 wherein said imaging errors comprise at least one of color aberration and image distortion.

12. The system of claim 1 wherein said lenses from said optical channels are formed into a compound lens.

13. The system of claim 1 wherein said displays from said optical channels are formed into a single display.

14. The system of claim 13 wherein said displays from said optical channels are separated from each other by empty display areas.

15. The system of claim 1 wherein each optical channel has an eye-display distance of no more than 30 mm.

16. A compound lens comprising
a plurality of lens portions, each portion cut from a donor lens having a short EFL, said lens portions glued together in a stacked arrangement.

17. A method comprising:
stacking optical channels, each optical channel comprising at least a portion of a lens and at least a portion of a display, each optical channel handling a portion of a phase space of an optical device; and
adapting an input image into image portions for projection from said displays, one per optical channel, said input image comprising data pixels each having a pixel display angle, said adapting comprising:
placing copies of each said data pixel into said image portions for those of said optical channels whose phase space includes said pixel display angle of said data pixel.

18. The method of claim 17 and also comprising:
providing per-optical-channel compensation to each associated said image portion to correct imaging errors of its associated lens, thereby to produce a per-channel corrected image portion; and
displaying each per-channel corrected image portion on its associated said display.

19. The method of claim 17 and also comprising tilting optical axes of said optical channels have with respect to each other.

20. The method of claim 17 and also comprising positioning at least one said display off-center with respect to an optical axis of its said lens.

21. The method of claim 17 and also comprising cutting at least one said lens from a donor lens.

22. The method of claim 21 wherein said cutting is asymmetric about an optical axis of its said donor lens.

23. The method of claim 17 and also comprising placing optical separators between neighboring said optical channels.

24. The method of claim 18 wherein said imaging errors comprise at least one of color aberration and image distortion.
